(19) United States
(12) Patent Application Publication
(10) Pub. No.: US 2017/0006465 A1
(43) Pub. Date: Jan. 5, 2017

(54) WIRELESS COMMUNICATIONS DEVICE, WIRELESS COMMUNICATIONS SYSTEM, AUTOMATIC SETTING METHOD, AND PROGRAM

(71) Applicant: NEC Corporation, Tokyo (JP)

(72) Inventor: Tomotsune NISHIMURA, Tokyo (JP)

(73) Assignee: NEC Corporation, Tokyo (JP)

(21) Appl. No.: 15/125,759

(22) PCT Filed: Mar. 11, 2015
(86) PCT No.: PCT/JP2015/001316

§ 371 Date: Sep. 13, 2016

(30) Foreign Application Priority Data
Mar. 17, 2014 (JP) 2014-053690

(51) Int. Cl. H04W 8/20; H04L 12/733; H04W 76/02; H04L 29/08

(52) U.S. Cl. CPC H04W 8/20; H04L 69/325; H04L 69/324; H04L 45/122; H04W 76/021

(57) ABSTRACT

[Problem] To provide a wireless communications device, a wireless communications system, an automatic setting method, and a program, whereby settings for communications via a network can be efficiently set between wireless communications devices connected by a wireless link. [Solution] A wireless communications device (1) having a reception unit (12) and a generation unit (14). The reception unit (12) receives, via the wireless link and from other wireless communications devices, data including setting information relating to the other wireless communications devices and for communicating via the network. The generation unit (14) uses the setting information relating to other wireless communications devices and generates setting information relating to the local device.

### TECHNICAL FIELD

The present invention relates to a wireless communications device, a wireless communications system, an automatic setting method, and a program, and in particular to a wireless communications device, a wireless communications system, an automatic setting method, and a program, by which communication with other wireless communications devices is performed via a wireless link.

### BACKGROUND ART

When installation work of a wireless communications device that communicates with other wireless communications devices is performed, an initial wireless setting such as a setting of a frequency, a setting of a modulation method, and the like for wireless communications with an opposite device is executed. This initial wireless setting is executed by connecting a terminal device to a wireless communications device by a worker to use the terminal device. Further, for wireless communications with the opposite device, a Point-to-Point wireless system is applied. In the Point-to-Point wireless system, wireless transmission is executed between a pair of wireless communications devices disposed oppositely.

Further, in some cases, a network including a plurality of wireless communications devices is formed, an NMS (Network Management System) is connected to the network, and communications such as allowing monitoring traffic to flow or the like are performed with each wireless communications device. Further, in some cases, the network is connected to a core network and communications such as allowing user traffic to flow or the like are performed with each wireless communications device. To perform these communications such as monitoring traffic and the like via a network, it is necessary to execute settings different from an initial wireless setting, such as a setting of an IP (Internet Protocol) address and the like. Conversely, when installation work of a wireless communications device is performed, a setting (network setting) of communications via a network is not executed in many cases. Here, a distance between wireless communications devices opposite to each other is frequently several tens km, for example, and these wireless communications devices are widely disposed in a country, a continent, and the like. Therefore, when the initial wireless setting and the network setting are executed at different timings, it is necessary to dispatch a worker multiple times to disposition places of devices widely disposed in such a manner, resulting in a problem of poor efficiency.

As a technique for executing a network setting, there is a method using, for example, a DHCP (Dynamic Host Configuration Protocol) server. Further, as a related technique, PTL 1 discloses a relay device capable of acquiring communications terminal information. The relay device according to PTL 1 extracts a MAC (Media Access Control) address of a connected communications terminal and inquires of a product server disposed externally about the extracted MAC address. When finding the MAC address inquired from the relay device on a database of the own server, the product server transmits, as a reply, communications terminal information corresponding to the MAC address to the relay device of the inquiry source. The relay device registers the communications terminal information on an extended MAC address table.

In the above-described technique, it is assumed that the device can communicate with a DHCP server or a product server. However, at a state where only an initial wireless setting has been executed, it is still difficult to communicate with the DHCP server or the like. As a technique for solving such a problem, PTL 2 discloses a communications device in which a management network is configured by connecting to another communications device different from the own device. The communications device according to PTL 2 includes an address generation unit that generates address information and a response request transmission unit that transmits a response request in which the address information generated by the address generation unit is assigned as a destination. Further, the communications device includes an address setting unit that sets the address information generated by the address generation unit as address information of the own device when receiving no response to the response request. Then, the address generation unit generates address information different from the address information generated last time when receiving a response to the response request.

### CITATION LIST

### Patent Literature

[PTL 1] Japanese Laid-open Patent Publication No. 2011-155462

[PTL 2] International Publication No. WO2012/086571

### SUMMARY OF INVENTION

### Technical Problem

In PTL 2 described above, it is not assumed that a communications device is being connected to another communications device via a wireless link. Therefore, in PTL 2, even when it has been difficult for the communications device to receive a response to a response request due to an interruption of the wireless link with the another communications device due to a wireless failure and the like, the communications device sets the address information generated by the address generation unit as address information of the own device. In other words, when the technique of PTL 2 is applied to wireless communications, address information overlapped with another communications device may be set as address information of the own device when the wireless link is interrupted due to a wireless failure and the like. Further, in PTL 2, a range (an address of a subnet or the like) of address information to be generated needs to be previously set by factory shipment settings or the like. Therefore, in PTL 2 described above, it has been difficult to efficiently execute a network setting between wireless communications devices connected by a wireless link.

To solve such problems, the present invention has been completed, and an object of the present invention is to provide a wireless communications device, a wireless communications system, an automatic setting method, and a program, which are capable of efficiently executing settings for communicating, via a network, between wireless communications devices connected by a wireless link.

### Solution to Problem

A wireless communications device, according to the present invention, comprises:

a reception means configured to receive, via a wireless link and from other wireless communications devices, data including setting information relating to the other wireless communications devices and for communicating via a network; and a generation means configured to generate the setting information relating to an own device using the setting information relating to the other wireless communications devices.

Further, a wireless communications system, according to the present invention, comprises:

a first wireless communications device; and

a second wireless communications device that is adjacent to the first wireless communications device and is connected to the first wireless to communications device via a wireless link,

the first wireless communications device transmitting, via the wireless link, data including setting information relating to the first wireless communications device and for communicating via a network to the second wireless communications device,

the second wireless communications device including
a reception means configured to receive, via the wireless link, the data including the setting information relating to the first wireless communications device transmitted from the first wireless communications device, and
a generation means configured to generate the setting information relating to the second wireless communications device using the setting information relating to the first wireless communications device.

Further, an automatic setting method, according to the present invention, comprises:

receiving, via a wireless link and from other wireless communications devices, data including setting information relating to the other wireless communications devices and for communicating via a network; and
generating the setting information relating to an own device using the setting information relating to the other wireless communications devices.

Further, a program, according to the present invention, that causes a computer to execute:

the step of receiving, via a wireless link and from other wireless communications devices, data including setting information relating to the other wireless communications devices and for communicating via a network; and

the step of generating the setting information relating to an own device using the setting information relating to the other wireless communications devices.

### Advantageous Effects of Invention

According to the present invention, it is possible to provide a wireless communications device, a wireless communications system, an automatic setting method, and a program, which are capable of efficiently executing settings for communicating, via a network, between wireless communications devices connected by a wireless link.

### BRIEF DESCRIPTION OF DRAWINGS

FIG. 1 is a diagram illustrating an outline of a wireless communications device according to an exemplary embodiment of the present invention.

FIG. 2 is a diagram illustrating a wireless communications system according to a first exemplary embodiment.

FIG. 3 is a function block diagram of a wireless communications device according to the first exemplary embodiment.

FIG. 4 is a sequence diagram illustrating communications between respective wireless communications devices according to the first exemplary embodiment.

FIG. 5 is a diagram exemplifying frame information transmitted/received between the respective wireless communications devices according to the first exemplary embodiment.

FIG. 6 is a flowchart exemplifying generation processing of setting information according to the first exemplary embodiment.

FIG. 7 is a diagram illustrating a wireless communications system according to a second exemplary embodiment.

FIG. 8 is a function block diagram of a wireless communications device according to the second exemplary embodiment.

FIG. 9 is a sequence diagram illustrating communications between respective wireless communications devices according to the second exemplary embodiment.

FIG. 10 is a diagram exemplifying frame information transmitted/received between the respective wireless communications devices according to the second exemplary embodiment.

FIG. 11 is a flowchart exemplifying relay processing executed in the wireless communications device according to the second exemplary embodiment.

FIG. 12 is a flowchart exemplifying generation processing of setting information according to the second exemplary embodiment.

### DESCRIPTION OF EMBODIMENTS

### Outline of an Exemplary Embodiment According to the Present Invention

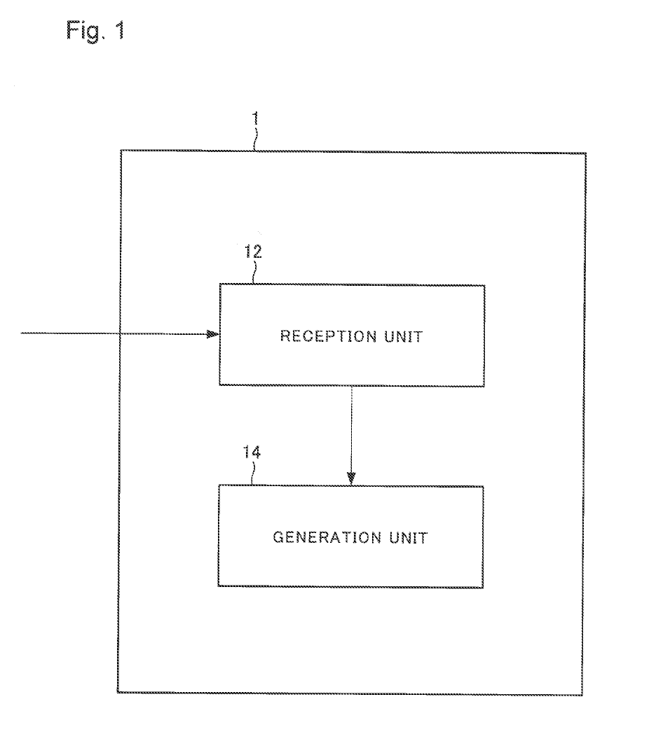

Prior to description of exemplary embodiments, an outline of an exemplary embodiment according to the present invention will be described using FIG. 1. FIG. 1 is a diagram illustrating an outline of a wireless communications device 1 according to the exemplary embodiment of the present invention. As illustrated in FIG. 1, the wireless communications device 1 includes a reception unit 12 (reception means) and a generation unit 14 (generation means).

The reception unit 12 receives, via a wireless link and from other wireless communications devices, data including setting information relating to the other wireless communications devices and for communicating via a network. The generation unit 14 generates setting information relating to an own device using the setting information relating to the other wireless devices.

According to the wireless communications device 1 according to the exemplary embodiment of the present invention, it is possible to efficiently execute settings for communicating, via a network, between wireless communications devices connected by a wireless link.

### First Exemplary Embodiment

Hereinafter, with reference to the drawings, a first exemplary embodiment will be described.

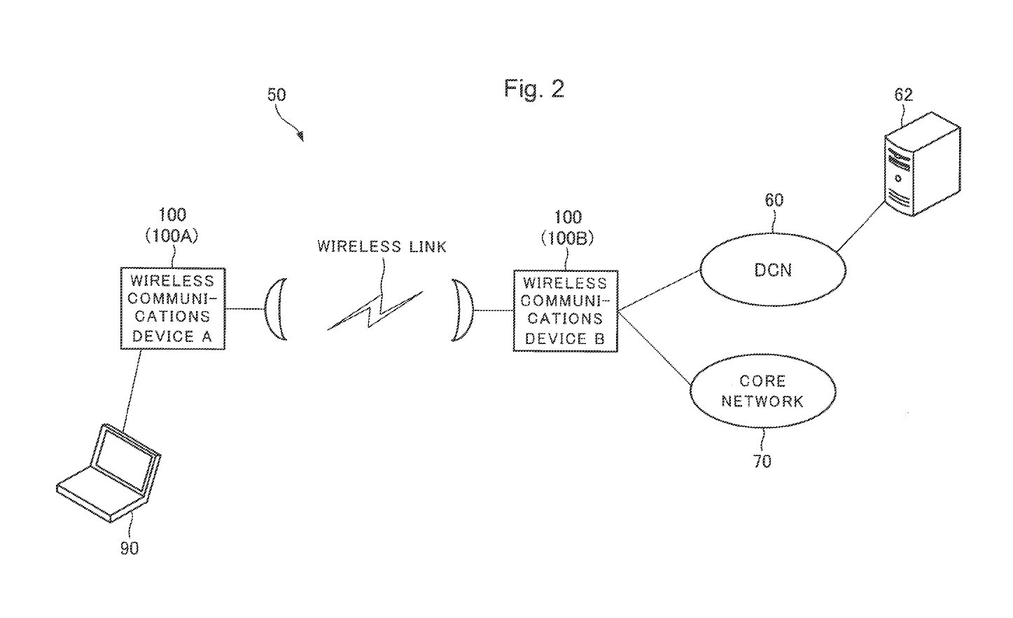

FIG. 2 is a diagram illustrating a wireless communications system 50 according to the first exemplary embodiment. The wireless communications system 50 includes a wireless communications device A 100A and a wireless communications device B 100B opposite to each other. The wireless communications device A 100A and the wireless communications device B 100B are communicably connectable via a wireless link. Further, the wireless communications device B 100B is communicably connectable to a management server 62 such as an NMS or the like via a DCN (Data Communication Network) 60. Furthermore, the wireless communications device B 100B is connectable to a core network 70. Further, the wireless communications device A 100A is connectable with a terminal device 90 such as an LCT (Local Craft Terminal) or the like.

Note that the wireless communications device A 100A and the wireless communications device B 100B may include the same components. Hereinafter, description will be made under an assumption that the wireless communications device A 100A and the wireless communications device B 100B include the same components. Further, hereinafter, the wireless communications device A 100A and the wireless communications device B 100B will be collectively referred to as a wireless communications device 100. In other words, when the wireless communications device A 100A and the wireless communications device B 100B are not discriminated, these devices may be collectively referred to as a wireless communications device 100.

The management server 62 executes transmission/reception of a monitoring signal to/from the wireless communications device A 100A and the wireless communications device B 100B via the DCN 60, when becoming communicable with the wireless communications device A 100A and the wireless communications device B 100B via a network. Here, the management server 62 performs communications (Layer 3 communications) conforming to Layer 3 protocol of an OSI (Open Systems Interconnection) reference model with the wireless communications device A 100A and the wireless communications device B 100B. Therefore, the management server 62 executes transmission/reception of a monitoring signal to/from the wireless communications device A 100A and the wireless communications device B 100B by Layer 3 communications.

The core network 70 executes transmission/reception of user data (a main signal) to/from the wireless communications device A 100A and the wireless communications device B 100B, when becoming communicable with the wireless communications device A 100A and the wireless communications device B 100B via the network. Here, the core network 70 performs Layer 3 communications with the wireless communications device A 100A and the wireless communications device B 100B. Therefore, the core network 70 executes transmission/reception of user data to/from the wireless communications device A 100A and the wireless communications device B 100B by Layer 3 communications.

When installation work of the wireless communications device A 100A and the wireless communications device B 100B is performed, a worker executes an initial wireless setting including a setting of a frequency, a setting of a modulation method, and the like for wireless communications with an opposite device. Here, the opposite device refers to the wireless communications device A 100A when the wireless communications device B 100B is assigned as an own device, and refers to the wireless communications device B 100B when the wireless communications device A 100A is assigned as an own device. This initial wireless setting is executed, and thereby the wireless communications device A 100A and the wireless communications device B 100B are communicably connected via a wireless link. Here, communications between the wireless communications device A 100A and the wireless communications device B 100B in this stage can be performed in conformity with Layer 2 protocol. In other words, the wireless communications device A 100A and the wireless communications device B 100B preform communications (Layer 2 communications) conforming to Layer 2 protocol via the wireless link.

Further, in this stage, in the wireless communications device A 100A and the wireless communications device B 100B, setting information for communicating via a network has not been set. The setting information refers to information for communicating via a network, and “set setting information” refers to “generate setting information and execute a network setting (so as to be able to perform Layer 3 communications). Further, the setting information is address information such as an IP address or the like of an own device, for example. In other words, a layer (e.g. Layer 3) relating to the setting information is superior to a layer (e.g. Layer 2) relating to a wireless link. Therefore, in this stage, it is difficult for the wireless communications device A 100A and the wireless communications device B 100B to perform Layer 3 communications. Therefore, it is difficult for the wireless communications device A 100A to communicate with the management server 62 and the core network 70. In this manner, it is difficult for the wireless communications device B 100B to communicate with the management server 62 and the core network 70.

Setting information of the wireless communications device A 100A is set by operating the terminal device 90 by the worker. On the other hand, the wireless communications device B 100B automatically generates setting information relating to the own device in accordance with reception of the setting information relating to the wireless communications device A 100A from the wireless communications device A 100A. Detailed description will be made later. Further, hereinafter, a case in which the setting information is an IP address will be described, but the setting information is not limited to an IP address.

Hereinafter, processing according to the first exemplary embodiment will be described.

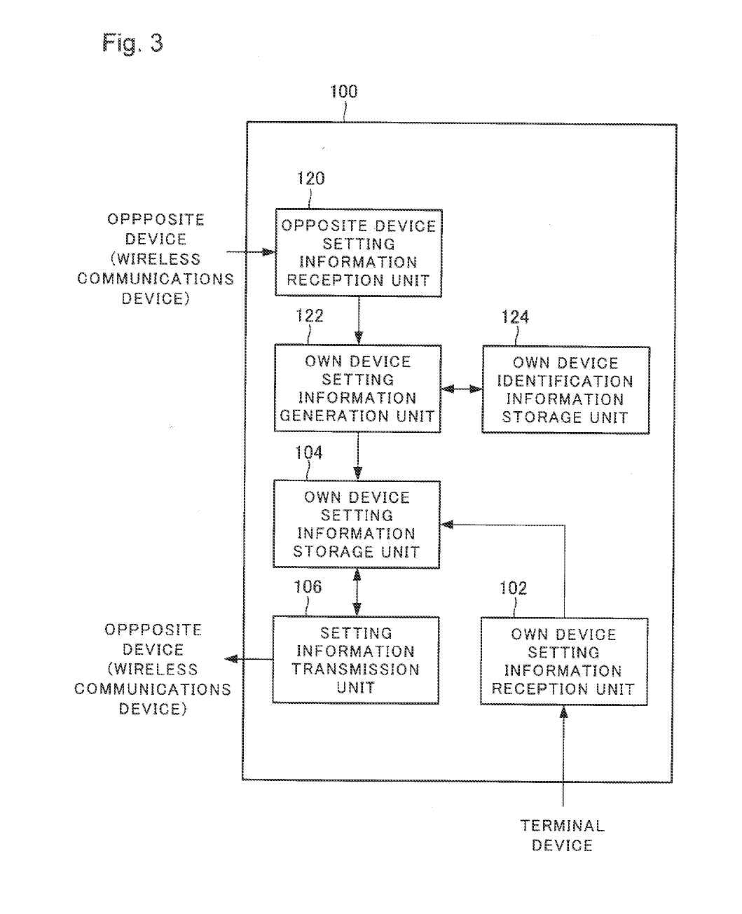

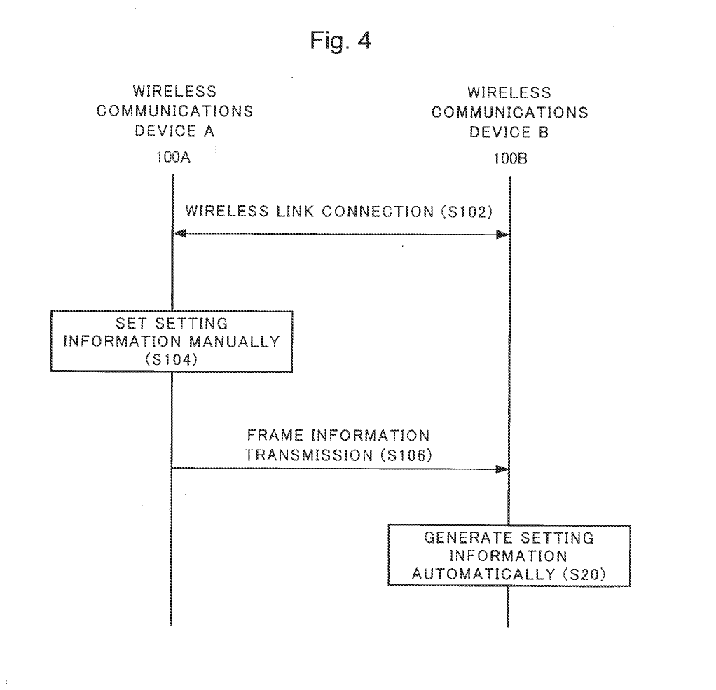

FIG. 3 is a function block diagram of the wireless communications device 100 according to the first exemplary embodiment. Further, FIG. 4 is a sequence diagram illustrating communications between the wireless communications device A 100A and the wireless communications device B 100B according to the first exemplary embodiment. The wireless communications device 100 includes an own device setting information reception unit 102, an own device setting information storage unit 104, a setting information transmission unit 106, an opposite device setting information reception unit 120, an own device setting information generation unit 122, and an own device identification information storage unit 124.

Note that the wireless communications device 100 may include not only the components illustrated in FIG. 3 but also a function as a computer.

In other words, the wireless communications device 100 may include an arithmetic device such as a CPU or the like, a storage device such as a memory or the like, a communications device, and an input/output device that is a user interface.

Further, respective components illustrated in FIG. 4 may be realized by causing an arithmetic device such as a CPU (Central Processing Unit) or the like to execute a computer program stored in a storage device such as a memory or the like. Further, the respective components may be realized by any one of combinations of hardware, firmware, and software, without limitation to realization using software based on a program. Further, the respective components illustrated in FIG. 4 may be realized using an integrated circuit programmable by a user, such as an FPGA (field-programmable gate array), a microcomputer, or the like. In this case, using this integrated circuit, a program including the respective components may be realized. This is the same in another exemplary embodiment.

Note that when the wireless communications device A 100A and the wireless communications device B 100B are disposed as illustrated in FIG. 2, in the wireless communications device A 100A, the own device setting information reception unit 102, the own device setting information storage unit 104, and the setting information transmission unit 106 function. Further, in this case, in the wireless communications device B 100B, the opposite device setting information reception unit 120, the own device setting information generation unit 122, the own device identification information storage unit 124, and the own device setting information storage unit 104 function.

The wireless communications device A 100A and the wireless communications device B 100B are connected by a wireless link (S 102). Specifically, a worker performs installation work of the wireless communications device A 100A and executes an initial wireless setting for the wireless communications device A 100A. In the same manner, the worker performs installation work of the wireless communications device B 100B and executes an initial wireless setting for the wireless communications device B 100B. Thereby, the wireless communications device A 100A and the wireless communications device B 100B can be connected by the wireless link. In other words, the wireless communications device A 100A and the wireless communications device B 100B are linked up, and Layer 2 communication can be performed between the wireless communications device A 100A and the wireless communications device B 100B.

In the wireless communications device A 100A, setting information relating to the wireless communications device A 100A is manually set (S 104). Specifically, the own device setting information reception unit 102 receives setting information input by operating the terminal device 90 by the worker and stores the received setting information in the own device setting information storage unit 104. Thereby, in the wireless communications device A 100A, the setting information is set.

The wireless communications device A 100A transmits frame information including the setting information of the own device to the wireless communications device B 100B via the wireless link (S106). Specifically, the setting information transmission unit 106 of the wireless communications device A 100A transmits frame information including the setting information of the own device to the wireless communications device B 100B via the wireless link, for example, by multicast. At that time, the setting information transmission unit 106 of the wireless communications device A 100A transmits the frame information to the wireless communications device B 100B by Layer 2 communications. Note that the transmission of the frame information may be executed in conformity with LLDP (Link Layer Discovery Protocol) specified in IEEE 802.1aB. The LLDP is a control protocol of Layer 2. Note that in this case, for ports of the wireless communications device A 100A and the wireless communications device B 100B, a default VLAN (Virtual Local Area Network) may be set as an initial value. Thereby, execution of only an initial wireless setting executed in installation work of the wireless communications device A 100A and the wireless communications device B 100B makes it possible for the wireless communications device A 100A and the wireless communications device B 100B to perform communications (LLDP communications) conforming to LLDP with each other.

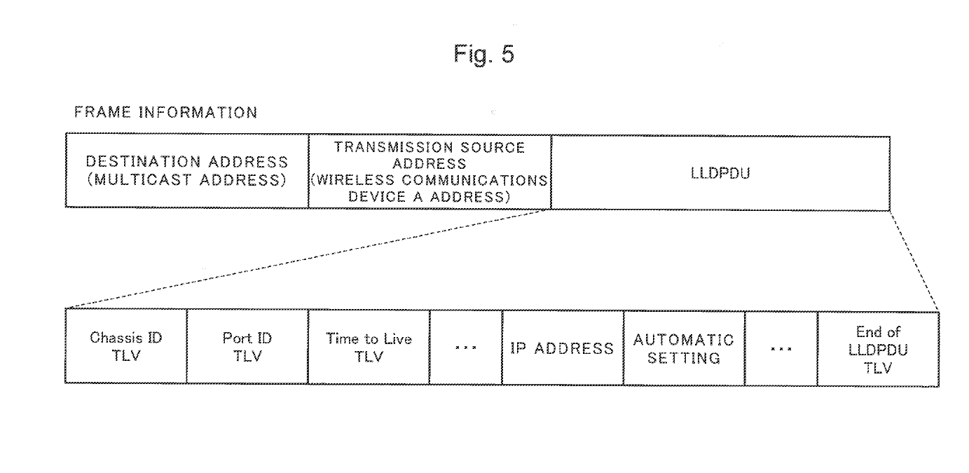

FIG. 5 is a diagram exemplifying frame information transmitted/received between the respective wireless communications devices 100 (the wireless communications device A 100A and the wireless communications device B 100B) according to the first exemplary embodiment. The frame information exemplified in FIG. 5 is, for example, a MAC (Media Access Control) frame. Further, the frame information exemplified in FIG. 5 is illustrative of a case of conforming to LLDP, but the frame information transmitted from the wireless communications device A 100A to the wireless communications device B 100B is not limited to the case of conforming to LLDP. Further, the frame information is not limited to a MAC frame.

As illustrated in FIG. 5. the frame information is data including at least a destination address, a transmission source address, and an LLDPDU (Data Unit). The destination address is a predetermined specific multicast address. Further, the transmission source address is an address relating to the wireless communications device A 100A.

The LLDPDU includes a plurality of TLV (type-length-value) components. Four components of a Chassis ID TLV, a Port ID TLV, a Time to Live TLV, and an End of LLDPDU TLV are necessary TLV components. In the example of FIG. 5, one optional TLV (or Reserved TLV) is defined as a TLV indicating an IP address. This TLV may include a net mask. Further, one optional TLV (or Reserved TLV) may be defined as a TLV indicating a function (automatic setting function) for causing an opposite device (here, the wireless communications device B 100B) to execute automatic settings.

Note that frame information including an LLDPDU may be transmitted from the wireless communications device A 100A to the wireless communications device B 100B multiple times. In this case, the transmission of the frame information including an LLDPDU may be executed every time an LLDP timer using a Time to Live TLV included in the LLDPDU expires. In the same manner, the frame information including an LLDPDU may be transmitted from the wireless communications device B 100B to the wireless communications device A 100A multiple times. At that time, an IP address for the wireless communications device B 100B has not been set, and therefore a TLV indicating an IP address and a TLV indicating an automatic setting function may be empty.

Further, due to an environment change or the like, sometimes, wireless quality between the wireless communications device A 100A and the wireless communications device B 100B is degraded and thereby a wireless link is interrupted. In this case, items (a setting of a frequency, a setting of a modulation method, and the like) set by the initial wireless setting for each of the wireless communications device A 100A and the wireless communications device B 100B are changed, and the wireless communications device A 100A and the wireless communications device B 100B are connected again by the wireless link. At that time, even before the LLDP timer expires, at a timing of change of the items set by the initial wireless setting, the frame information including an LLDPDU may be transmitted.

In this manner, when the items set by the initial wireless setting have been changed due to degradation of wireless quality between the wireless communications device A 100A and the wireless communications device B 100B, the frame information including an LLDPDU may be transmitted before expiration of the LLDP timer. Such a configuration makes it possible to transmit again the frame information including an LLDPDU even when the wireless link is interrupted due to degradation of wireless quality.

The wireless communications device B 100B automatically generates setting information (S20). Specifically, the opposite device setting information reception unit 120 of the wireless communications device B 100B receives the frame information from the wireless communications device A 100A and outputs the received frame information to the own device setting information generation unit 122. The own device setting information generation unit 122 generates setting information relating to the own device using the setting information relating to the wireless communications device A 100A included in the frame information from the wireless communications device A 100A and stores the generated setting information in the own device setting information storage unit 104. At that time, the own device setting information generation unit 122 may generate setting information relating to the own device, when a TLV indicating an automatic setting function included in the LLDPDU of the frame information makes an instruction for automatically setting the setting information.

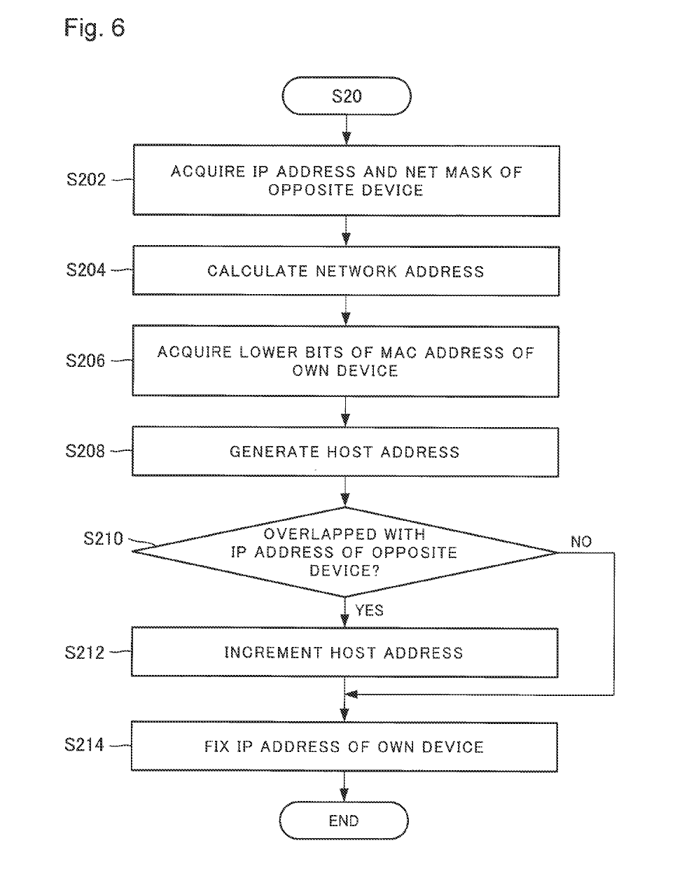

FIG. 6 is a flowchart exemplifying generation processing (S20) of setting information according to the first exemplary embodiment. In the example of FIG. 6, a case in which the setting information is an IP address is illustrated.

The wireless communications device B 100B acquires an IP address and a net mask (subnet mask) of an opposite device (the wireless communications device A 100A) (S202). Specifically, the own device setting information generation unit 122 of the wireless communications device B 100B acquires an IP address and a net mask from the LLDPDU included in the frame information received from the opposite device (the wireless communications device A 100A).

The wireless communications device B 100B uses the IP address and the net mask relating to the opposite device (the wireless communications device A 100A) and thereby calculates a network address configuring an IP address relating to the own device (the wireless communications device B 100B) (S204). Specifically, the own device setting information generation unit 122 executes an AND operation for the IP address and the net mask relating to the opposite device and calculates a network address. Thereby, an IP address can be set in the same subnet between the wireless communications device A 100A and the wireless communications device B 100B.

The wireless communications device B 100B acquires lower bits of a MAC address relating to the own device (S206). Specifically, the own device setting information generation unit 122 extracts a MAC address (own device identification information) stored in the own device identification information storage unit 124. Then, the own device setting information generation unit 122 acquires, for example, lower 32 bits of 48 bits of the MAC address.

The wireless communications device B 100B generates a host address configuring the IP address relating to the own device (S208).

Specifically, the own device setting information generation unit 122 extracts bits used as a host address from the lower 32 bits of the MAC address acquired in the processing of S206. It is assumed that, for example, of 32 bits of an IP address, 24 bits are allocated to a network address. In this case, the bit number of the host address is the remaining 8 bits (32 bits−24 bits). At that time, the own device setting information generation unit 122 extracts further lower 8 bits of the lower 32 bits of the MAC address acquired in the processing of S206.

The own device setting information generation unit 122 generates the extracted lower 8 bits of the MAC address as 8 bits of the host address.

Thereby, an IP address including the network address generated in the processing of S204 and the host address generated in the processing of S208 is temporarily generated as an IP address relating to the wireless communications device B 100B.

The wireless communications device B 100B determines whether or not the IP address of the own device temporarily generated in the above processing is overlapped with the IP address of the opposite device (S210). Specifically, the own device setting information generation unit 122 of the wireless communications device B 100B determines whether or not the temporarily generated IP address relating to the own device and the IP address relating to the wireless communications device A 100A that is the opposite device are overlapped. When the IP address of the own device and the IP address of the wireless communications device A 100A are not overlapped (NO in S210), the own device setting information generation unit 122 of the wireless communications device B 100B fixes the temporarily generated IP address relating to the own device as an IP address relating to the own device (S214).

On the other hand, when the IP address of the own device and the IP address of the wireless communications device A 100A are overlapped (YES in S210), the own device setting information generation unit 122 of the wireless communications device B 100B increments the host address generated in the processing of S208 (S212). Then, the own device setting information generation unit 122 fixes an IP address including the network address generated in the processing of S204 and the host address incremented in the processing of S212 as an IP address relating to the wireless communications device B 100B (S214). Thereby, for the wireless communications device B 100B, an IP address that falls within the same subnet as for the wireless communications device A 100A and is not overlapped with that of the wireless communications device A 100A is automatically generated.

As described above, in the first exemplary embodiment, a network setting of one wireless communications device (the wireless communications device A 100A) is executed, and thereby a network setting of an opposite device (the wireless communications device B 100B) is automatically executed. In other words, when a network setting of an opposite device (the wireless communications device A 100A) is executed, a network setting of an own device (the wireless communications device B 100B) is automatically executed. Therefore, it is unnecessary for a worker to travel to the wireless communications device B 100B in order to execute a network setting. In other words, it is unnecessary for the worker to travel to a plurality of sites in order to execute network settings. Therefore, in the present exemplary embodiment, network settings are efficiently executable between wireless communications devices connected by a wireless link. Further, without previously setting a part of address information by an own device (the wireless communications device B 100B), the address information is automatically settable in the own device (the wireless communications device B 100B).

Further, as described above, in the first exemplary embodiment, even when a wireless link is interrupted due to an environment change or the like, the wireless communications device A 100A and the wireless communications device B 100B are connected again by the wireless link, and thereby the wireless communications device A 100A can transmit frame information to the wireless communications device B 100B. Therefore, in the first exemplary embodiment, a network setting can be more reliably executed between wireless communications devices connected by a wireless link, regardless of a change of wireless quality due to an environment change or the like.

### Second Exemplary Embodiment

Next, a second exemplary embodiment will be described. Note that components that are substantially the same as in the first exemplary embodiment are assigned with the same reference signs, and therefore description thereof will be omitted.

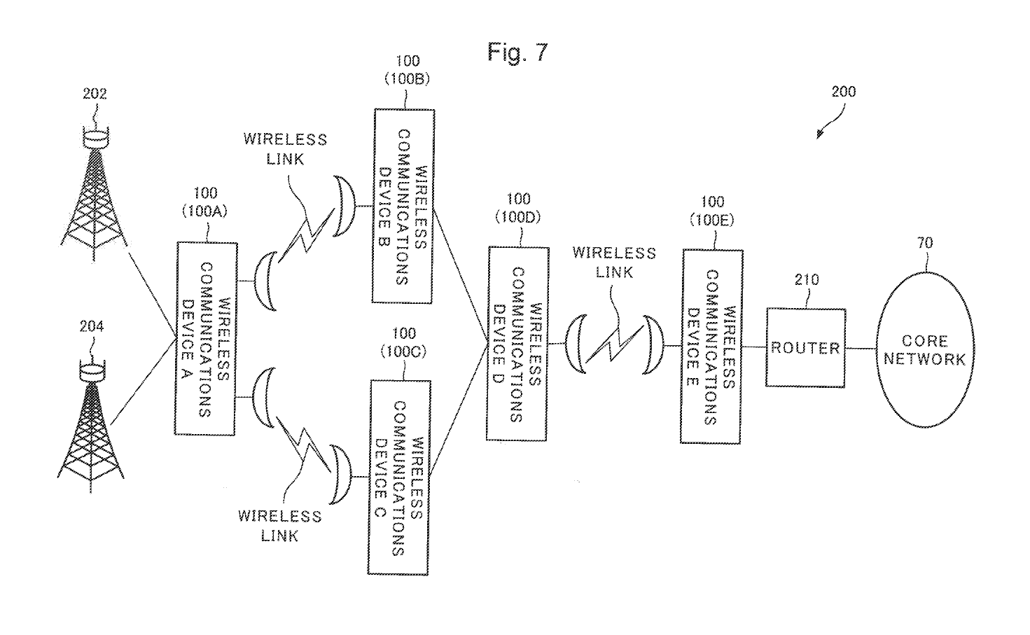

FIG. 7 is a diagram illustrating a wireless communications system 200 according to the second exemplary embodiment. The wireless communications system 200 includes a wireless communications device A 100A, a wireless communications device B 100B, a wireless communications device C 100C, a wireless communications device D 100D, and a wireless communications device E 100E. The wireless communications device A 100A is connected to base stations 202 and 204, for example, via a wired line. Further, the wireless communications device E 100E is connectable to a core network 70 via a router 210.

Further, the wireless communications device A 100A and the wireless communications device B 100B are communicably connectable via a wireless link. In the same manner, the wireless communications device A 100A and the wireless communications device C 100C are communicably connectable via a wireless link. Further, the wireless communications device D 100D is connected to the wireless communications device B 100B, for example, via a wired line. In the same manner, the wireless communications device D 100D is connected to the wireless communications device C 100C, for example, via a wired line. Further, the wireless communications device D 100D and the wireless communications device E 100E are communicably connectable via a wireless link.

Here, the wireless communications device D 100D has been assumed to be connected to the wireless communications device B 100B and the wireless communications device C 100C via a wired line but may be connected thereto via a wireless line (wireless link). Further, hereinafter, the expression “adjacent to other wireless communications devices 100” includes a case of connection established to other wireless communications devices 100 via a wireless link and a case of connection established to other wireless communications devices 100 via a wired line. In other words, for example, the wireless communications device D 100D is adjacent to the wireless communications device B 100B and the wireless communications device C 100C. In the same manner, the wireless communications device D 100D is adjacent to the wireless communications device E 100E. Further, as illustrated in FIG. 7, the wireless communications device D 100D is not adjacent (is not directly connected) to the wireless communications device A 100A. In other words, the wireless communications device A 100A is present ahead of the wireless communications device B 100B (or the wireless communications device C 100C) adjacent to the wireless communications device D 100D. Note that hereinafter, the terms “adjacent” and “opposite” may be used as the same meaning.

The core network 70 executes, when being communicable with the respective wireless communications devices 100 (the wireless communications device A 100A, the wireless communications device B 100B, the wireless communications device C 100C, the wireless communications device D 100D, and the wireless communications device E 100E) via a network, transmission/reception of user data (a main signal) to/from the respective wireless communications devices 100. Here, the core network 70 performs Layer 3 communications with the wireless communications device 100. Therefore, the core network 70 performs transmission/reception of user data to/from the respective wireless communications devices 100.

Further, in the same manner as in the first exemplary embodiment, when installation work of the respective wireless communications devices 100 is performed, a worker executes an initial wireless setting including a setting of a frequency, a setting of a modulation method, and the like for wireless communications with an adjacent device (opposite device). Here, in the same manner as in the first exemplary embodiment, communications between the respective wireless communications devices 100 via a wireless link in this stage can be performed in conformity with Layer 2 protocol.

Further, in the same manner as in the first exemplary embodiment, in this stage, in the respective wireless communications devices 100, setting information for communicating via a network has not been set. Therefore, in this stage, it is difficult for the wireless communications device A 100A and the other wireless communications devices 100 to perform Layer 3 communications. Therefore, it is difficult for the wireless communications device A 100A to communicate with the core network 70. Therefore, it is difficult for the wireless communications device A 100A to transmit data of the core network 70 to the base stations 202 and 204 via the other wireless communications devices 100.

Further, in the same manner as in the first exemplary embodiment, in the second exemplary embodiment, for example, setting information of the wireless communications device A 100A is set by operating the terminal device 90 by the worker. On the other hand, the wireless communications device B 100B and the wireless communications device C 100C automatically generate setting information relating to the own device in accordance with reception of the setting information relating to the wireless communications device A 100A from the wireless communications device A 100A. Further, the wireless communications device D 100D automatically generates setting information relating to the own device in accordance with reception of the setting information relating to the wireless communications device B 100B from the wireless communications device B 100B (or in accordance with reception of the setting information relating to the wireless communications device C 100C from the wireless communications device C 100C). Further, the wireless communications device E 100E automatically generates setting information relating to the own device in accordance with reception of the setting information relating to the wireless communications device D 100D from the wireless communications device D 100D.

Hereinafter, processing according to the second exemplary embodiment will be described.

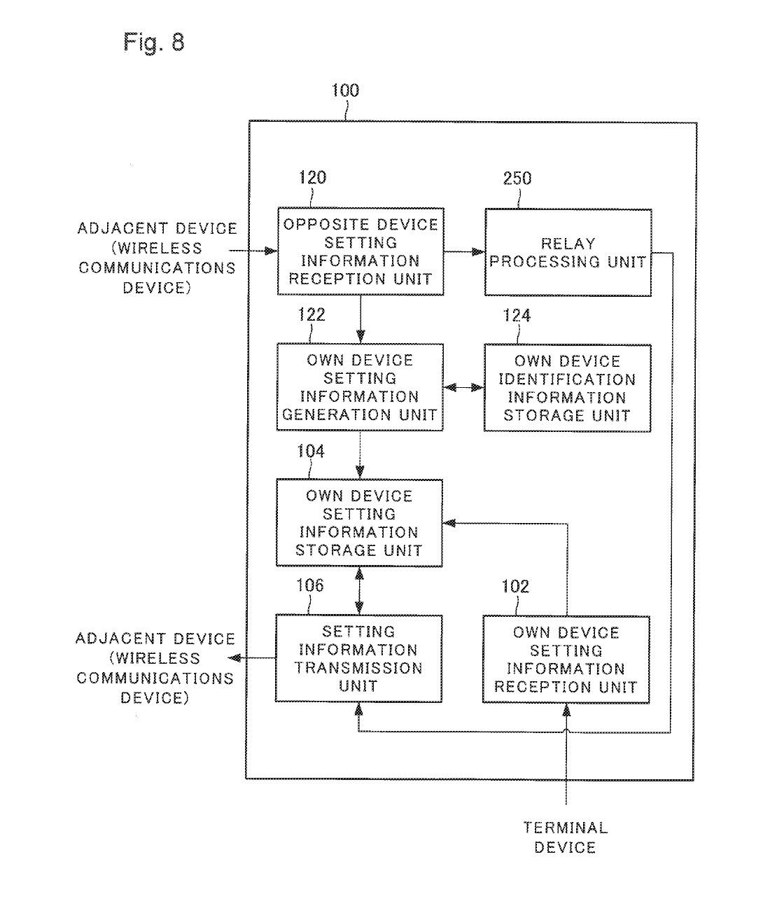

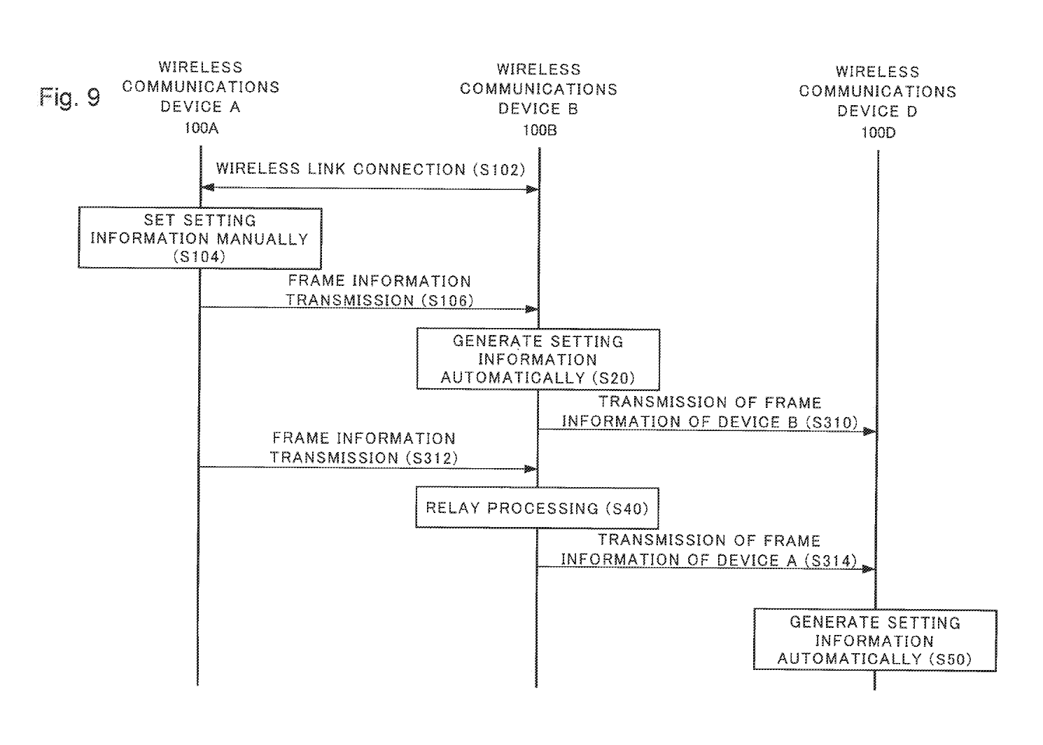

FIG. 8 is a function block diagram of a wireless communications device 100 according to the second exemplary embodiment. Further, FIG. 9 is a sequence diagram illustrating communications between a wireless communications device A 100A, a wireless communications device B 100B, and a wireless communications device D 100D according to the second exemplary embodiment.

The wireless communications device 100 includes an own device setting information reception unit 102, an own device setting information storage unit 104, a setting information transmission unit 106, an opposite device setting information reception unit 120, an own device setting information generation unit 122, an own device identification information storage unit 124, and a relay processing unit 250. The wireless communications device 100 according to the second exemplary embodiment is different from the wireless communications device 100 according to the first exemplary embodiment in a point that the former includes the relay processing unit 250. Here, the relay processing unit 250 is disposed between two other wireless communications devices 100 and can function in a device that relays communications between these two wireless communications devices 100, as in at least the wireless communications device B 100B, a wireless communications device C 100C, and the wireless communications device D 100D.

In the same manner as the processing according to the first exemplary embodiment (the processing illustrated in FIG. 4), through processing of S102 to S20, for the wireless communications device B 100B, setting information of the own device is automatically generated. Note that in FIG. 9, the processing of S102 to S20 is substantially the same as the processing according to the first exemplary embodiment (the processing illustrated in FIG. 4), and therefore description thereof will be omitted.

The wireless communications device B 100B transmits frame information including setting information relating to the wireless communications device B 100B to the wireless communications device D 100D (S310). Specifically, the setting information transmission unit 106 of the wireless communications device B 100B transmits frame information including setting information relating to the own device to the wireless communications device D 100D via a wired line, for example, by multicast. At that time, the setting information transmission unit 106 of the wireless communications device B 100B transmits the frame information to the wireless communications device D 100D by Layer 2 communications. In other words, in the frame information relating to S310, the wireless communications device B 100B is assumed as a transmission source. This frame information includes the setting information generated in the processing of S20.

The wireless communications device A 100A transmits frame information to the wireless communications device B 100B via a wireless link (S312). Specifically, the setting information transmission unit 106 of the wireless communications device A 100A transmits frame information including setting information of the wireless communications device A 100A to the wireless communications device B 100B via a wireless link, for example, by multicast. In other words, in this frame information, the wireless communications device A 100A is assumed as a transmission source.

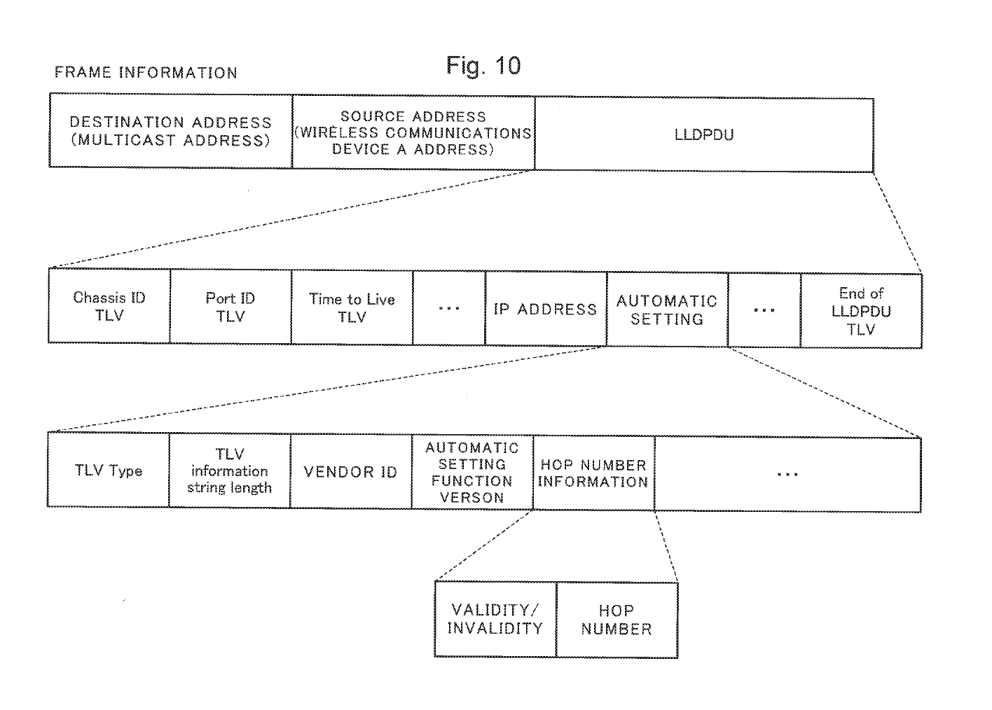

FIG. 10 is a diagram exemplifying frame information transmitted/received between the respective wireless communications devices 100 according to the second exemplary embodiment. The frame information exemplified in FIG. 10 is different from the frame information exemplified in FIG. 5 according to the first exemplary embodiment in a point that a TLV indicating an automatic setting function is specifically illustrated. The other points are the same as in the first exemplary embodiment.

The TLV indicating an automatic setting function (automatic setting function TLV) may include at least a TLV Type, a TLV information string length, a vendor ID, an automatic setting function version, hop number information, and other fields (Reserved and the like). Here, the TLV information string length indicates a data length of the following fields. Further, the automatic setting function version specifies what type of setting an adjacent device is caused to execute. The automatic setting function version indicates, for example, an instruction for automatically generating setting information.

The hop number information is information on how the respective wireless communications devices 100 are disposed. In other words, the hop number information is associated with a disposition between the respective wireless communications devices 100.

The hop number information includes a field (validity/invalidity field) indicating validity/invalidity and a field (hop number field) indicating a hop number. The validity/invalidity field sets whether to cause a relay function of the wireless communications device 100 to be valid or invalid. Further, the hop number field indicates through how many wireless communications devices 100 frame information has been relayed from the wireless communications device 100 of a transmission source of the frame information.

When, for example, frame information is transmitted from a wireless communications device 100 (e.g. the wireless communications device A 100A) of a transmission source, the hop number field indicates “1”. Then, when the frame information is relayed (hopped) by a next wireless communications device 100 (e.g. the wireless communications device B 100B) of the wireless communications device 100 of the transmission source, the next wireless communications device 100 rewrites the hop number field to “2” and transfers (relays) the frame information. In the same manner, when the frame information is relayed (hopped) by a further next wireless communications device 100 (e.g. the wireless communications device D 100D), the further next wireless communications device 100 rewrites the hop number field to “3” and transfers (relays) the frame information.

The wireless communications device B 100B executes relay processing (S40). Specifically, the opposite device setting information reception unit 120 of the wireless communications device B 100B receives frame information from the wireless communications device A 100A and outputs hop number information included in the frame information to the relay processing unit 250. The relay processing unit 250 executes relay processing, as described later, using the hop number information. Then, the wireless communications device B 100B transmits, when it is determined that a relay is performed in the relay processing, the frame information in which the wireless communications device A 100A is the transmission source to the wireless communications device D 100D (S314). Then, the wireless communications device D 100D automatically generates, as described later, setting information of the own device using the frame information (setting information) relating to the wireless communications device B 100B received in the processing of S310 and the frame information (setting information) relating to the wireless communications device A 100A received in the processing of S314 (S50).

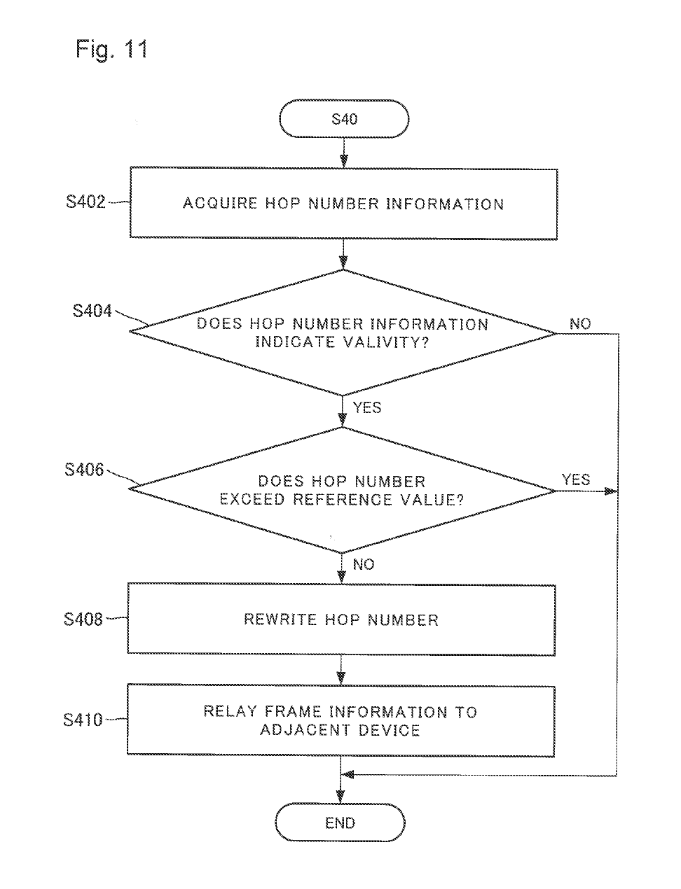

FIG. 11 is a flowchart exemplifying the relay processing (S40) executed in the wireless communications device 100 according to the second exemplary embodiment. Hereinafter, processing in the wireless communications device B 100B will be exemplified. However, this processing is also executable in any other optional wireless communications device 100.

The wireless communications device B 100B acquires hop number information included in frame information transmitted from an adjacent device (the wireless communications device A 100A) (S402). Specifically, as described above, the opposite device setting information reception unit 120 of the wireless communications device B 100B receives frame information from the wireless communications device A 100A and outputs the hop number information included in the frame information to the relay processing unit 250. Thereby, the relay processing unit 250 acquires the hop number information.

The relay processing unit 250 of the wireless communications device B 100B determines whether or not a validity/invalidity field of the hop number information indicates “validity” (S404). When the validity/invalidity field indicates “invalidity” (NO in S404), the relay processing unit 250 does not transmit (relay) the frame information from the wireless communications device A 100A to the wireless communications device D 100D that is an adjacent device and terminates the processing.

On the other hand, when the validity/invalidity field indicates “validity” (YES in S404), the relay processing unit 250 determines whether or not a hop number indicated in the hop number field exceeds a reference value (S406). This reference value is a value previously determined on the basis of how many wireless communications devices 100 are provided in the wireless communications system 200. Further, the reference value may be previously determined on the basis of a disposition configuration of the wireless communications devices 100 included in the same subnet. The reference value may be set so as to be different among the respective wireless communications devices 100.

For example, regarding the wireless communications device B 100B, in FIG. 7, one (one-hop) wireless communications device 100 (the wireless communications device A 100A) is disposed on the left side, and two (two-hop) wireless communications devices 100 (the wireless communications device D 100D and the wireless communications device E 100E) are disposed on the right side. Therefore, as the reference value, “2” that is a larger value may be set. Further, in accordance with a fact that hop number information is included in frame information received from which one of the wireless communications devices 100, different reference values may be applicable. For example, for hop number information included in frame information received from the wireless communications device A 100A, a reference value “1” may be applicable, and for hop number information included in frame information received from the wireless communications device D 100D, a reference value “2” may be applicable. Note that in this case, for the hop number information included in the frame information received from the wireless communications device A 100A, a reference value “2” may be applicable in also consideration of reception of frame information from the wireless communications device C 100C.

When the hop number exceeds the reference value (YES in S406), the relay processing unit 250 does not relay the frame information from the wireless communications device A 100A to the wireless communications device D 100D and terminates the processing. On the other hand, when the hop number does not exceed the reference number (NO in S406), the relay processing unit 250 rewrites a hop number indicated in the hop number field (S408). When, for example, the hop number field indicates “1,” the relay processing unit 250 rewrites the hop number field to “2”.

Then, the wireless communications device B100B relays the frame information to an adjacent device (the wireless communications device D 100D) (S410).

The case in which the hop number exceeds the reference value is the following case. In FIG. 7, the wireless communications device A 100A, the wireless communications device B 100B, the wireless communications device C 100C, and the wireless communications device D 100D form a loop. In this case, the respective wireless communications devices 100 relay frame information by multicast, and therefore frame information transmitted, for example, from the wireless communications device A 100A may circulate in the loop. In other words, the frame information transmitted from the wireless communications device A 100A may be relayed many times through the respective wireless communications devices 100 configuring the loop. Therefore, when a hop number indicated in the hop number field exceeds a reference value, the frame information is assumed to circulate in the loop and a relay of the frame information is not further performed.

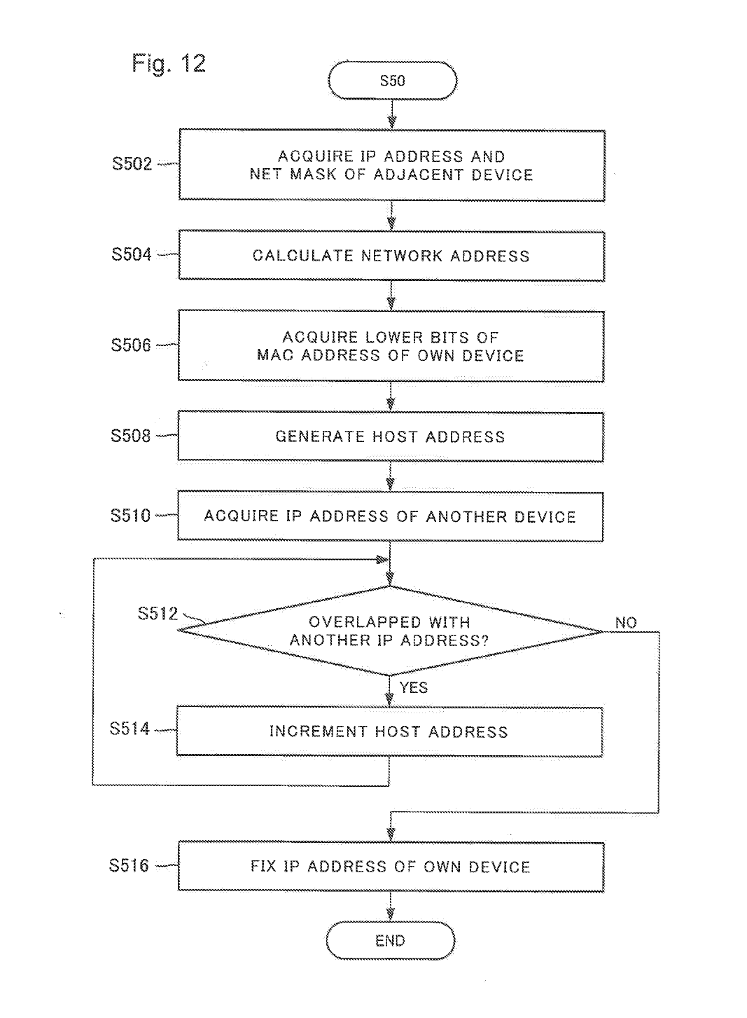

Note that in the above-described example, the hop number field has been assumed to increase every time a relay is performed, but may be configured to decrease every time a relay is performed. When frame information is transmitted, for example, from a wireless communications device 100 (e.g. the wireless communications device A 100A) of a transmission source, the hop number field may indicate a hexadecimal “0×FF”. Then, when the frame information is relayed (hopped) by a next wireless communications device 100 (e.g. the wireless communications device B 100B) of the wireless communications device 100 of the transmission source, the next wireless communications device 100 may rewrite the hop number field to “0×FE”. In the same manner, when the frame information is relayed (hopped) by a further next wireless communications device 100 (e.g. the wireless communications device D 100D), the further next wireless communications device 100 may rewrite the hop number field to “0×FD”. In this case, the reference value may be set to be smaller with an increase in the number of wireless communications devices 100 that perform a relay to the respective wireless communications devices 100. FIG. 12 is a flowchart exemplifying generation processing (S50) of setting information according to the second exemplary embodiment. In the example of FIG. 12, a case in which the setting information is an IP address is illustrated.

The own device setting information generation unit 122 of the wireless communications device D 100D acquires an IP address and a net mask of an adjacent device (e.g. the wireless communications device B 100B) in the same manner as the processing of S202 (S502). Next, the own device setting information generation unit 122 of the wireless communications device D 100D calculates a network address configuring an IP address relating to an own device (the wireless communications device D 100D) using the IP address and the net mask relating to the adjacent device (e.g. the wireless communications device B 100B) in the same manner as the processing of S204 (S504). Next, the own device setting information generation unit 122 of the wireless communications device D 100D acquires lower bits of a MAC address relating to the own device in the same manner as the processing of S206 (S506). Next, the wireless communications device D 100D generates a host address configuring the IP address relating to the own device in the same manner as the processing of S208 (S508). Thereby, an IP address including the network address generated in the processing of S504 and the host address generated in the processing of S508 is temporarily generated as an IP address relating to the wireless communications device D 100D.

The wireless communications device D 100D acquires an IP address of another device other than the adjacent device (S510). Specifically, the own device setting information generation unit 122 of the wireless communications device D 100D acquires the frame information in which the wireless communications device A 100A is a transmission source and which is received in the processing of S314, and extracts an IP address of the wireless communications device A 100A included in the frame information. Note that FIG. 9 illustrates that the wireless communications device D 100D seems to communicate with only the wireless communications device B 100B, but actually receives frame information also from the wireless communications device C 100C. Therefore, when a setting of an IP address for the wireless communications device C 100C has been completed, the own device setting information generation unit 122 acquires frame information in which the wireless communications device C 100C is a transmission source and extracts the IP address of the wireless communications device C 100C included in the frame information.

The wireless communications device D 100D determines whether or not the IP address of the own device temporarily generated in the above-described processing is overlapped with the IP address of another wireless communications device 100 (S512). Specifically, the own device setting information generation unit 122 of the wireless communications device D 100D determines whether or not the temporarily generated IP address relating to the own device is matched with the IP address of the wireless communications device B 100B (and the IP address of the wireless communications device C 100C) that is an adjacent device. Further, the own device setting information generation unit 122 of the wireless communications device D 100D determines whether or not the temporarily generated IP address relating to the own device is matched with the IP address of the wireless communications device A 100A present ahead of the wireless communications device B 100B.

When the IP address of the own device is not overlapped with the IP address of the another wireless communications device 100 (NO in S512), the own device setting information generation unit 122 of the wireless communications device D 100D fixes the temporarily generated IP address relating to the own device as an IP address relating to the own device in the same manner as the processing of S214 (S516).

On the other hand, when the IP address of the own device is overlapped with the IP address of the another wireless communications device 100 (YES in S512), the own device setting information generation unit 122 of the wireless communications device D 100D increments the host address generated in the processing of S508 (S514). This increment processing is repeated until the IP address of the own device is overlapped with the IP addresses of none of other wireless communications devices 100 (the wireless communications device A 100A, the wireless communications device B 100B, and the wireless communications device C 100C) acquired by the wireless communications device D 100D. While, for example, the IP address of the own device has been overlapped with the IP address of the wireless communications device B 100B and therefore a host address of the IP address has been incremented, the own device setting information generation unit 122 of the wireless communications device D 100D further increments, when an IP address after increment is overlapped with the IP address of the wireless communications device A 100A, a host address of the IP address of the own device.

Thereby, for the wireless communications device D 100D, an IP address that falls within the same subnet as for the wireless communications device A 100A, the wireless communications device B 100B, and the wireless communications device C 100C and is not overlapped with the IP addresses of the wireless communications device A 100A, the wireless communications device B 100B, and the wireless communications device C 100C is automatically generated. Further, by the same processing, also for the wireless communications device E 100E, an IP address that falls within the same subnet as for the respective wireless communications devices 100 and is not overlapped with the IP addresses of the respective wireless communications devices 100 is automatically generated.

In the second exemplary embodiment, the automatic setting method according to the first exemplary embodiment is applied to the entire network including a plurality of wireless communications devices 100. Therefore, even when a wireless communications system includes a plurality of wireless communications devices 100, when a network setting is executed for one wireless communications device (the wireless communications device A 100A in the above-described example), network settings are automatically executed also for other wireless communications devices 100. Therefore, it is unnecessary for a worker to travel to a plurality of wireless communications devices 100 in order to execute network settings. Therefore, in the present exemplary embodiment, network settings are efficiently executable between wireless communications devices connected by a wireless link. Still further, without previously setting a part of address information by an own device (the wireless communications device B 100 B, the wireless communications device D 100D, or the like), the address information is automatically settable in the own device.

Further, in Layer 2 communications, frame information is terminated between the devices and is not relayed to another device. On the other hand, in the second exemplary embodiment, frame information includes hop number information, and when this hop number information is used, the wireless communications device 100 can determine which one of the wireless communications devices 100 is a transmission source for received frame information (setting information).

In the above-described example, for example, the wireless communications device D 100D receives frame information (setting information) in which the wireless communications device B 100B is a transmission source and frame information (setting information) in which the wireless communications device A 100A is a transmission source. At that time, the wireless communications device D 100D can determine that frame information in which the hop number field of hop number information indicates “1” is frame information in which the wireless communications device B 100B is a transmission source. Therefore, the wireless communications device D 100D can determine that setting information included in the frame information is setting information relating to the wireless communications device B 100B. In the same manner, the wireless communications device D 100D can determine that frame information in which the hop number field of hop number information indicates “2” is frame information in which the wireless communications device A 100A is a transmission source. Therefore, the wireless communications device D 100D can determine that setting information included in the frame information is setting information relating to the wireless communications device A 100A. Further, in the processing of S50, the own device setting information generation unit 122 may be configured to identify the wireless communications device 100 that is a transmission source of frame information (LLDPDU) using hop number information, as described above.

Further, the wireless communications device D 100D has been assumed to automatically generate setting information relating to the own device in accordance with reception of setting information relating to the wireless communications device B 100B (or the wireless communications device C 100C), but is not limited to such a configuration. The wireless communications device D 100D may receive, for example, setting information relating to the wireless communications device A 100A relayed by the wireless communications device B 100B and temporarily generate setting information (an IP address and the like) relating to the own device in the processing of S502 to S508 using the setting information relating to the wireless communications device A 100A.

### MODIFIED EXAMPLES

Note that the present invention is not limited to the exemplary embodiments and can be appropriately modified without departing from the spirit of the present invention. In the above-described flowcharts, an order of processes (steps) can be appropriately modified. Further, at least one of a plurality of processes (steps) may be omitted. For example, the processing of S102 of FIG. 4 and FIG. 9 may be executed after the processing of S104.

Further, the processing of S312 of FIG. 9 need not exist. In other words, frame information (setting information relating to the wireless communications device A 100A) transmitted from the wireless communications device A 100A in the processing of S106 may be relayed in the processing of S40. Further, the processing of S40 may be executed before the processing of S20. Further, as described in the first exemplary embodiment, transmission of frame information in S106 may be periodically executed, and the wireless communications device B 100B may execute the processing of S40 every time that receives frame information from the wireless communications device A 100A.

Further, in the above-described exemplary embodiments, setting information has been described as an IP address, but the setting information is not limited to address information such as an IP address or the like. The setting information may be, for example, information on QoS (Quality of Service), may be information for determining what piece of user data is preferentially transmitted, or may be information on a VLAN.

Further, in the second exemplary embodiment, the number of the wireless communications devices 100 has been assumed to be 5, but the number of the wireless communications devices 100 is optional. Further, a device configuration of the wireless communications system 200 according to the second exemplary embodiment is optional. For example, the router 210 may be connected to the management server 62 via a network, and the wireless communications device D 100D may be connected to the base station 202.

Further, in the second exemplary embodiment, the wireless communications device 100 in which setting information is manually set has been assumed to be the wireless communications device A 100A, but the wireless communications device 100 in which setting information is manually set is optional. For example, in the wireless communications device B100B, setting information may be manually set. In this case, the wireless communications device B 100B may transmit frame information including setting information of the own device to the wireless communications device A 100A and the wireless communications device D 100D that are adjacent devices by multicast or the like.

In the above-described examples, a program is stored using a various types of non-transitory computer readable medium and can be supplied to a computer. The non-transitory computer readable medium includes various types of tangible storage medium. Examples of the non-transitory computer readable medium include a magnetic recording medium (e.g. a flexible disk, a magnetic tape, and a hard disk drive), a magnetooptical recording medium (e.g. a magnetooptical disk), a CD-ROM (Read Only Memory), a CD-R, a CD-R/W, a semiconductor memory (e.g. a mask ROM, a PROM (Programmable ROM), an EPROM (Erasable PROM), a flash ROM, and a RAM (Random Access Memory)). Further, the program may be supplied to the computer using various types of transitory computer readable medium. Examples of the transitory computer readable medium include electric signals, optical signals, and electromagnetic waves. The transitory computer readable medium can supply the program to the computer via a wired communication path such as an electric wire, an optical fiber, and the like or a wireless communications path.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2014-053690, filed on Mar. 17, 2014, the disclosure of which is incorporated herein in its entirety by reference.

### REFERENCE SIGNS LIST

1 Wireless communications device

12 Reception unit

14 Generation unit

50 Wireless communications system

62 Management server

70 Core network

90 Terminal device

100 Wireless communications device

102 Own device setting information reception unit

104 Own device setting information storage unit

106 Setting information transmission unit

120 Opposite device setting information reception unit

122 Own device setting information generation unit

124 Own device identification information storage unit

200 Wireless communications system

250 Relay processing unit

1. A wireless communications device comprising:
a reception unit configured to receive, via a wireless link and from other wireless communications devices, data including setting information relating to the other wireless communications devices and for communicating via a network; and
a generation unit configured to generate the setting information relating to an own device using the setting information relating to the other wireless communications devices.

2. The wireless communications device according to claim 1, wherein a layer relating to the setting information is superior to a layer relating to the wireless link.

3. The wireless communications device according to claim 2, wherein the wireless link relates to Layer 2 protocol, and the setting information relates to Layer 3 protocol.

4. The wireless communications device according to claim 1, wherein
the generation unit generates address information of the setting information relating to the own device so as to be different from address information of the setting information relating to the other wireless communications devices.

5. The wireless communications device according to claim 4, wherein
the generation unit generates, on the basis of the setting information relating to the other wireless communications devices and identification information of the own device, the setting information relating to the own device.

6. The wireless communications device according to claim 1, wherein
the reception unit receives, from at least one second other wireless communications device present ahead of a first other wireless communications device adjacent to the own device, the data relayed by the first other wireless communications device, and
the generation unit generates the setting information relating to the own device using the setting information relating to the second other wireless communications device.

7. The wireless communications device according to claim 6, wherein
the reception unit receives the data transmitted from the first other wireless communications device, and
the generation unit generates the setting information relating to the own device so as to be different from the setting information relating to the first other wireless device and the setting information relating to the second other wireless communications device.

8. The wireless communications device according to claim 7, wherein
the data includes hop number information associated with a disposition between a plurality of wireless communications devices, and
the reception unit receives the data that includes the setting information relating to the second other wireless communications device transmitted from the second other wireless communications device and is relayed by the first other wireless communications device in accordance with the hop number information.

9. The wireless communications device according to claim 1, further comprising
a relay unit configured to relay the data transmitted from the other wireless communications devices to a wireless communications device that is adjacent to the own device and is different from the other wireless communications devices.

10. A wireless communications system comprising:
a first wireless communications device; and
a second wireless communications device that is adjacent to the first wireless communications device and is connected to the first wireless communications device via a wireless link,
the first wireless communications device transmitting, via the wireless link, data including setting information relating to the first wireless communications device and for communicating via a network to the second wireless communications device,
the second wireless communications device including
a reception unit configured to receive, via the wireless link, the data including the setting information relating to the first wireless communications device transmitted from the first wireless communications device, and
a generation unit configured to generate the setting information relating to the second wireless communications device using the setting information relating to the first wireless communications device.

11. The wireless communications system according to claim 10, wherein
a layer relating to the setting information is superior to a layer relating to the wireless link.

12. The wireless communications system according to claim 11, wherein
the wireless link relates to Layer 2 protocol, and the setting information relates to Layer 3 protocol.

13. The wireless communications system according to claim 10, wherein
the generation unit generates address information of the setting information relating to the second wireless communications device so as to be different from address information of the setting information relating to the first wireless communications devices.

14. The wireless communications system according to claim 10, further comprising:
a third wireless communications device that is adjacent to the second wireless communications device and includes the reception unit and the generation unit,
the second wireless communications device further including
a relay unit configured to relay the data transmitted from the first wireless communications device to the third wireless communications device,
the generation unit of the third wireless communications device generating the setting information relating to the third wireless communications device using the setting information relating to the first wireless communications device.

15. The wireless communications system according to claim 14, wherein
the reception unit of the third wireless communications device receives the data transmitted from the second wireless communications device, and
the generation unit of the third wireless communications device generates the setting information relating to the third wireless communications device so as to be different from the setting information relating to the first wireless communications device and the setting information relating to the second wireless communications device.

16. The wireless communications system according to claim 14, wherein
the data includes hop number information associated with a disposition between a plurality of wireless communications devices, and
the relay unit of the second wireless communications device relays the data transmitted from the first wireless communications device to the third wireless communications device in accordance with the hop number information.

17. An automatic setting method comprising:
receiving, via a wireless link and from other wireless communications devices, data including setting information relating to the other wireless communications devices and for communicating via a network; and
generating the setting information relating to an own device using the setting information relating to the other wireless communications devices.

18. The automatic setting method according to claim 17, wherein
a layer relating to the setting information is superior to a layer relating to the wireless link.

19. The automatic setting method according to claim 18, wherein
the wireless link relates to Layer 2 protocol, and the setting information relates to Layer 3 protocol.

20. The automatic setting method according to claim 17, comprising
generating address information of the setting information relating to the own device so as to be different from address information of the setting information relating to the other wireless communications devices.

21. The automatic setting method according to claim 20, comprising
generating, on the basis of the setting information relating to the other wireless communications devices and identification information of the own device, the setting information relating to the own device.

22. The automatic setting method according to claim 17, comprising:
receiving, from at least one second other wireless communications device present ahead of a first other wireless communications device adjacent to an own device, the data relayed by the first other wireless communications device; and
generating the setting information relating to the own device using the setting information relating to the second other wireless communications device.

23. The automatic setting method according to claim 22, comprising:
receiving the data transmitted from the first other wireless communications device; and
generating the setting information relating to the own device so as to be different from the setting information relating to the first other wireless device and the setting information relating to the second other wireless communications device.

24. The automatic setting method according to claim 23, wherein
the data includes hop number information associated with a disposition between a plurality of wireless communications devices, and
the method comprises receiving the data that includes the setting information relating to the second other wireless communications device transmitted from the second other wireless communications device and is relayed by the first other wireless communications device in accordance with the hop number information.

25. A non-transitory information recording medium recording a program that causes a computer to execute:
the step of receiving, via a wireless link and from other wireless communications devices, data including setting information relating to the other wireless communications devices and for communicating via a network; and
the step of generating the setting information relating to an own device using the setting information relating to the other wireless communications devices.

26. A wireless communications device comprising:
a reception means configured to receive, via a wireless link and from other wireless communications devices, data including setting information relating to the other wireless communications devices and for communicating via a network; and
a generation means configured to generate the setting information relating to an own device using the setting information relating to the other wireless communications devices.

27. A wireless communications system comprising:
a first wireless communications device; and
a second wireless communications device that is adjacent to the first wireless communications device and is connected to the first wireless communications device via a wireless link,
the first wireless communications device transmitting, via the wireless link, data including setting information relating to the first wireless communications device and for communicating via a network to the second wireless communications device,
the second wireless communications device including
a reception means configured to receive, via the wireless link, the data including the setting information relating to the first wireless communications device transmitted from the first wireless communications device, and
a generation means configured to generate the setting information relating to the second wireless communications device using the setting information relating to the first wireless communications device.
